(19) United States
(12) Patent Application Publication
(10) Pub. No.: US 2012/0164268 A1
(43) Pub. Date: Jun. 28, 2012

(54) Confectionery Composition

(76) Inventor: Sarah Pearson, Palmerston (AU)

(21) Appl. No.: 13/393,860

(22) PCT Filed: Aug. 31, 2010
(86) PCT No.: PCT/GB2010/001646

§ 371 Date: Mar. 2, 2012

(30) Foreign Application Priority Data
Sep. 2, 2009 (GB) 0915265.3

(51) Int. Cl. A23G 3/54; A23G 4/18

(52) U.S. Cl. 426/5; 426/103; 426/102; 426/282; 426/665

(57) ABSTRACT

The present invention relates to a confectionery composition which is able to provide a new and improved flavour and texture experience for a consumer. The confectionery composition has interconnected pores therein which contain a fill material.

### CROSS-REFERENCE TO RELATED APPLICATIONS

The present application is the National Stage filing of International Application No. PCT/GB2010/001646, filed Aug. 31, 2010, which claims priority to GB 0915265.3, filed Sep. 2, 2009, the contents of each of which are incorporated by reference herein.

### FIELD OF THE INVENTION

The present invention relates to a confectionery composition, particularly to a confectionery composition having interconnected pores therein which are at least partially filled with a fill material, and to a method for preparing the same. The confectionery composition of the invention provides a novel and improved flavour and texture experience for a consumer.

### BACKGROUND OF THE INVENTION

There is a never-ending search in the confectionery industry for new and innovative confectionery compositions which can provide different and interesting experiences for consumers. This can be done by employing different flavours, or by using different textures which provide a different mouthfeel sensation.

One such breakthrough in confectionery texture experiences came some time ago in the form of confectionery compositions having a porous structure or a honeycomb structure with closed pores, such as the product marketed as Crunchie®. Such products have both been around for nearly 80 years.

Similarly, confectionery compositions having a liquid centre fill give a different sensation to ‘conventional’ chocolate bars. Such products have also been available for many years, and typically take the form of an external confectionery shell having an internal cavity which is filled with the liquid centre. Examples of such products include the Cadbury Creme Egg (1923) and the Cadbury Caramel bar.

### SUMMARY OF THE INVENTION

It is a goal of the present invention to provide a confectionery composition which can provide a novel flavour and/or texture experience for a consumer.

Therefore, in accordance with the invention, there is provided a confectionery composition having interconnected pores which are at least partially filled with a fill material.

Also provided in accordance with the invention is a method of producing a confectionery composition having interconnected pores which are at least partially filled with a fill material, comprising the steps of:
i) providing an edible porous structure having interconnected pores; and
ii) at least partially filling the pores with an edible fill material.

### BRIEF DESCRIPTION OF THE FIGURES

The invention will now be described further by way of example with reference to the following figures which are intended to be illustrative only and in no way limiting upon the scope of the invention.

FIG. 1 shows two cross-sectional representations of confectionery compositions of the invention with an interconnected porous matrix structures filled with fill materials.

FIG. 2 shows two samples of cocoa butter passing through a brioche, one sample containing a surfactant and one without.

FIGS. 3-6 show four different embodiments of confectionery compositions according to the invention.

### DETAILED DESCRIPTION OF THE INVENTION

The porous structure may be achieved by, for example, preparing a confectionery foam, such as a honeycomb, candy foam or chocolate foam made up of interconnected pores.

The manufacture of such confectionery compositions having at least partially filled interconnected pores presents practical problems. Specifically, the natural rate of infiltration of the fill material into a porous structure at the usual pore sizes encountered is extremely slow. The rate of infiltration can be accelerated by the application of, for example, external pressures. However, such external pressures cause damage to the integrity of the fragile porous structure, which often collapses under the extra pressure.

The inventors have however devised a method for producing the confectionery compositions having interconnected pores which are at least partially filled with a fill material which allows for a more rapid and efficient infiltration of the fill material and does not require external pressure or any other aid which may damage the integrity of the porous structure.

Therefore, also provided in accordance with the present invention is a method of producing a confectionery composition having interconnected pores which are at least partially filled with a fill material, the method comprising using a surfactant to modify flow properties of the fill material to increase the rate of filling the pores.

The presence of the surfactant allows the fill material to infiltrate the interconnected pores more quickly. This allows for a sufficiently high rate of infiltration to enable a more rapid and more efficient larger scale production of the confectionery composition. The use of a surfactant is also especially suited to using a combination of more than one fill material, either where the fill materials have different phases and/or where the respective fill materials can form different phases at different temperatures.

It is believed that the use of a surfactant for such a purpose, i.e. to increase the infiltration rate of a flowable material into another material, has never before been explored in the confectionery and foodstuff industries.

For use in confectionery compositions, the surfactant will be a food grade surfactant and may comprise any food grade surfactant known to the skilled addressee. The surfactant may be selected from one or more of polyoxyethylenesorbitan monolaurate, Palsgaard 4150, or PGPR (polyglycerol polyricinoleate, a fat soluble surfactant), sodium lauryl sulphate, sodium stearoyl lactylate, potassium oleate, sucrose monoester, sodium oleate, polyoxyethylene (20) sorbitan monpalmitate, sucrose monolaurate, decaglycerol dioleate, polyoxyethylene (20) sorbitan tristearate, polyoxyethylene (20) sorbitan trioleate, hexaglycerol dioleate, sorbitan monolaurate, diacetyl tartaric acid esters of monoglycerides, soylecithin (SN), decaglycerol hexaoleate, triglycerol monostearate, sorbitan monopalmitate, glycerol monolaurate, calcium stearoyl lactylate, sucrose trimester, sorbitan monostearate, propylene glycol monolaurate, sorbitan monooleate, glycerol monostearate, glycerol monooleate, propylene glycol monostearate, ammonium phosphatides (YN), sorbitan tristearate, sorbitan trioleate, glycerol dioleate, acetic acid esters of mono glycerides, oleic acid, polyglycerolpolyricinoleate, lecithins, alginic acid, sodium alginate, potassium alginate, ammonium alginate, calcium alginate, propan-1,2-diol alginate, agar, carrageenan, locust bean gum, guar gum, tragacanth, gum arabic, xanthan gum, glycerol, polysorbate 20 (sold commercially as TWEEN 20), polysorbate 80 (TWEEN 80), polysorbate 40 (TWEEN 40), polysorbate 60 (TWEEN 60), polysorbate 65 (TWEEN 65), pectin, amidated pectin, ammonium phosphatides, methylcellulose, hydroxypropylcellulose, hydroxypropylmethylcellulose, ethylmethylcellulose, sodium, potassium and calcium salts of fatty acids, glyceryl monostearate, acetic acid esters, lactic acid esters, citric acid esters, tartaric acid esters, mono and diacetyltartaric acid esters, sucrose esters of fatty acids, sucroglycerides, polyglycerol esters of fatty acids, polyglycerol polyricinoleate, propan-1,2-diol esters of fatty acids, sodium stearoyl-2 lactate, calcium stearoyl-2 lactate.

According to a further aspect of the invention, there is also provided a use of a surfactant in modifying flow properties of a fill material in the preparation of a confectionery composition.

Typically, the fill material comprises a liquid material, or a material which is liquid at a temperature greater than room temperature. It will be apparent to the skilled addressee that room temperature is commonly regarded as around 20° C.

The fill material may be any mobile phase, such as a flowable food grade material. The fill material is typically a liquid which has a relatively high level of viscosity so that when a consumer bites into the final product the fill material does not simply flow out of the exposed pores. Typically, the fill material can include, but is not limited to, fruit juice; vegetable juice; fruit puree; fruit pulp; vegetable pulp; vegetable puree; fruit sauce; vegetable sauce; honey; maple syrup; molasses; corn syrup; sugar syrup; polyol syrup; hydrogenated starch hydrolysates syrup; emulsions; vegetable oil; glycerin; propylene glycol; ethanol; liqueurs; chocolate syrup, dairy-based liquids such as milk, cream, etc.; mousse; gel; fondant; butter; cocoa butter; jam; a gelatin-comprising solution; an isomalt-comprising solution; icing sugar; and combinations thereof. One advantageous fill material comprises a low sugar chocolate liquid which gives a product having a lower sugar content and a novel flavour and texture.

According to one embodiment of the invention, the method of producing a confectionery composition according to the invention further comprises the step of mixing the fill material with a surfactant, prior to at least partially filling the pores with a fill material.

According to a further embodiment, the fill material is heated to above about room temperature prior to being used to at least partially fill the pores.

According to a further embodiment, the step of at least partially filling the pores with a fill material comprises at least partially submerging the porous material in a quantity of liquefied fill material.

As used herein, the term ‘confectionery composition’ refers to any edible or chewable confectionery composition.

As used herein, the term ‘liquid’ refers to substances which will readily flow or maintain fluid properties at room temperature and pressure. The term ‘liquid’ may include solutions, suspensions, emulsions, semi-solids, creams, gels, etc, that may not be completely liquid, within its meaning.

As used herein, the term ‘edible’ refers to any substances which are intended for human or animal consumption and which are not expected to cause any significant negative physiological effect upon the consumer.

The compositions also may include any components known in the art for incorporation with centre-fill compositions. In some embodiments, the fill material may include glycerine in addition to one or more other polyols. In some embodiments, the fill material may contain traditional ingredients well known in the confectionery arts, such as flavouring agents, sweetening agents, and the like, and mixtures thereof. In addition to confectionery additives, the fill material may also contain pharmaceutical additives such as medicaments, breath fresheners, vitamins, minerals, caffeine, fruit juices, and the like, and mixtures thereof.

The confectionery and pharmaceutical agents may be used in many distinct physical forms well known in the art to provide an initial burst of sweetness and flavour and/or therapeutic activity or a prolonged sensation of sweetness and flavour and/or therapeutic activity. Without being limited thereto, such physical forms include free forms, such as spray dried, powdered, and beaded forms, and encapsulated forms, and mixtures thereof. Illustrative, but not limiting, examples of liquid centres suitable for use in some embodiments include those centres disclosed in U.S. Pat. Nos. 3,894,154, 4,156,740, 4,157,402, 4,316,915, and 4,466,983, which disclosures are incorporated herein by reference. Specific examples of suitable additional components include taurine, guarana, vitamins, Actizol®, chlorophyll, Recaldent® tooth remineralization technology, and Retsyn® breath freshening technology.

According to a further aspect, the fill material for the confectionery composition may comprise two or more components. The two or more components may either have different phases and/or form different phases at different temperatures.

For example, according to some embodiments of the invention, the fill material may contain a mixture of two or more distinct components, which may or may not be miscible with each other. The two or more components and/or semi-solids employed in the confectionery composition may be included in the same or different amounts and may have similar or distinct characteristics. More specifically, in some embodiments, the two or more components may differ in a variety of characteristics, such as for example, viscosity, colour, flavour, taste, texture, sensation, ingredient components, functional components and/or sweeteners.

Additional additives, such as warming agents, cooling agents, tingling agents, flavours, sweeteners, sour tastes, bitter tastes, salty tastes, surfactants, breath freshening agents, anti-microbial agents, anti-bacterial agents, anti-calculus agents, antiplaque agents, fluoride compounds, remineralization agents, pharmaceuticals, micronutrients, throat care actives, tooth whitening agents, energy boosting agents, concentration boosting agents, appetite suppressants, colours and other actives may also be included in any or all portions or regions of the confectionery composition. Such components may be used in amounts sufficient to achieve their intended effects; the respective effective amounts required being readily recognised by persons skilled in the art.

According to one embodiment, the interconnected pores are located towards a central portion of the confectionery composition.

According to another embodiment, the interconnected pores are located towards a peripheral position of the confectionery composition.

According to another embodiment, the confectionery composition comprises two or more (such as 3, 4, 5, 6, 7 or 8) separate areas which contain interconnected pores. These areas may be uniformly or irregularly located within the confectionery composition as desired.

According to another embodiment, the confectionery composition further comprises a coating layer which at least partially surrounds the interconnected pores.

The porous structure may be at least partially surrounded by a confectionery component, and more typically the porous structure is completely surrounded by the confectionery component. The confectionery component is typically a confectionery shell which encompasses the porous structure and may comprise hard candy, chewy candy, crunchy candy or soft candy, or may comprise chocolate or a chewing gum (or bubble gum) base, having an inner porous matrix structure. The matrix may comprise the same material as the confectionery shell, or it may comprise a different material. The confectionery component may comprise a hard, crunchy, chewy, panned sugar coating or soft shell as required.

As used herein, the terms “surround”, “surrounding”, and the like are not limited to encircling. These terms may refer to enclosing or confining on all sides, encircling, enveloping or enrobing, and are not limited to symmetrical or identical thicknesses for a region in the confectionery product.

The confectionery composition may also further include a coating layer, which can provide a crunchiness to the confectionery when initially consumed. The individual pieces of the confectionery composition may form a variety of shapes including pellet, tablet, ball, pillow, bar, chunk, stick and slab, among others.

Typically, the coating layer may include sorbitol, maltitol, xylitol, erythritol, isomalt, and other crystallisable polyols. Sucrose may also be used. The coating layer may include one or more opaque layers, such that the inner e.g. the porous structure is not visible through the coating itself. The coating may optionally be covered with a further one or more transparent layers for aesthetic, textural and protective purposes. The coating layer may also contain small amounts of water and gum arabic, and may be further coated with wax.

The coating may be applied in a conventional manner by successive applications of a coating solution, with drying in between the application of each coat. As the coating dries it usually becomes opaque and is usually white, though other colorants may be added. A polyol coating can be further coated with wax.

According to a further embodiment, the porous structure may itself at least partially surround a central portion of a confectionery composition. The central portion may comprise, for example, a gum base component, a component comprising hard candy, soft candy or crunchy candy, or a further liquid component which may be selected from one or more of those suitable as the fill material.

The confectionery composition may also further comprise an outer shell, which may comprise a hard, crunchy or soft shell.

In some embodiments, the coating may also be formulated to assist with increasing the thermal stability of the confectionery composition and preventing leakage of the fill material. In some embodiments, the coating may include a gelatin composition. The gelatin composition may be added as an about 40% by weight solution and may be present in the coating composition from about 5% to about 10% by weight of the coating composition, and more specifically about 7% to about 8%. The gel strength of the gelatin may be from about 130 bloom to about 250 bloom.

Other materials may be added to the coating to achieve desired properties. These materials may include without limitation, cellulosics such as carboxymethyl cellulose, gelatin, pullulan, alginate, starch, carrageenan, xanthan gum, gum arabic and polyvinyl acetate (PVA).

The coating composition may also include a pre-coating which is added to the individual confectionery products prior to an optional hard coating.

Various other coating compositions and methods of producing are also contemplated including but not limited to soft panning, dual or multiple extrusion, lamination, etc.

According to one embodiment of the invention, the interconnected pores and/or coating comprises chocolate, gum, hard candy, chewy candy, crunchy candy or soft candy.

Suitable sugar sweeteners for use in the confectionery composition will be apparent to the skilled addressee and may include monosaccharides, disaccharides and polysaccharides such as but not limited to, sucrose (sugar), dextrose, maltose, dextrin, xylose, ribose, glucose, mannose, galactose, fructose (levulose), lactose, invert sugar, fructo oligosaccharide syrups, partially hydrolyzed starch, corn syrup solids and mixtures thereof.

Suitable sugarless sweetening agents for use in the confectionery composition will also be apparent to the skilled addressee and may include sugar alcohols (or polyols) such as, but not limited to, sorbitol, xylitol, mannitol, galactitol, maltitol, hydrogenated isomaltulose (isomalt), lactitol, erythritol, hydrogenated starch hydrolysate, stevia and mixtures thereof.

In some embodiments, the confectionery composition may comprise a number of additional components, such as: high-intensity sweeteners, colouring agents, antioxidants and preservatives. Lubricants also may be added in some embodiments to improve the smoothness of the confectionery product, such as, for example hard candy embodiments. Suitable lubricants include, but are not limited to, fats, oils, aloe vera, pectin and combinations thereof.

Other conventional additives known to one having ordinary skill in the art also may be used in the confectionery compositions of the invention. The fill material also may include at least one flavour agent and/or at least one cooling agent.

In some embodiments, the components of the confectionery composition may be in different configurations depending on the desired shape of the total composition. The porous structure or structures may be in either a concentric configuration with respect to the confectionery component or in a layered configuration. A concentric configuration may be acceptable for a ball, pillow or pellet shape, while a layered configuration may be more suitable for a slab or a stick shape. For example, if the total composition is in a ball shape, a hollow, circular shell may be formed in the innermost region of the piece. The shell may be filled with a porous structure at least partially filled by the fill material, and the other regions or layers of the piece may encircle the porous structure. However, if the total composition is in a slab shape, a hollow shell formed in the innermost region may be of a rectangular shape. The rectangular-shaped shell may be filled with a porous structure at least partially filled by the fill material, and the other regions or layers of the piece may enclose or confine the rectangular centre filled area on all sides of the rectangle.

In some embodiments, the confectionery component may have a non-uniform thickness. In particular, the confectionery region in layered configuration embodiments may be thinner on the ends than on the sides of the piece.

Xanthan gum may also be used to increase the viscosity of the fill material(s) if required. In some embodiments, increasing the viscosity of the liquid also helps prevent the liquid from leaking through the confectionery component.

When the confectionery comprises a gum, it may comprise a gum base. The gum base may include any component known in the chewing gum (or bubble gum) art. For example, the gum region may include elastomers, bulking agents, waxes, elastomer solvents, emulsifiers, plasticizers, fillers and mixtures thereof.

In some other embodiments, for instance, two different components that provide the same functionality, e.g. two different flavours, sweeteners, tastes, sensations, or the like, may be included in a confectionery composition. In some embodiments, both components may have modified release properties. Alternatively, in some embodiments, one of the components may be modified release, whereas the other component may be free. The two components may be included in the same or different regions of the confectionery composition, so that the act of chewing mixes the two components together.

Types of individual ingredients for which optional managed release from a confectionery composition may be desired, include, but are not limited to sweeteners, flavours, actives, effervescing ingredients, appetite suppressors, breath fresheners, dental care ingredients, emulsifiers, flavour potentiators, bitterness masking or blocking ingredients, food acids, micronutrients, sensates, mouth moistening ingredients, throat care ingredients, colours, sour agents, bitter agents, salty agents, pharmaceuticals, energy boosting agents, concentration boosting agents and combinations thereof. Ingredients may be available in different forms such as, for example, liquid form, spray-dried form, or crystalline form. In some embodiments, the ingredient may be in its free or encapsulated form and may be present in any region of the confectionery composition such as in the fill material, or its coating.

In some embodiments, flavourings for the confectionery compositions may include those flavours known to the skilled artisan, such as natural and artificial flavours. These flavourings may be chosen from synthetic flavour oils and flavouring aromatics and/or oils, oleoresins and extracts derived from plants, leaves, flowers, fruits, and so forth, and combinations thereof. Non-limiting representative flavour oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavourings are artificial, natural and synthetic fruit flavours such as vanilla, and citrus oils including lemon, orange, lime, grapefruit, yazu, sudachi, and fruit essences including apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya and so forth. Other potential flavours whose release profiles can be managed include a milk flavour, a butter flavour, a cheese flavour, a cream flavour, and a yogurt flavour; a vanilla flavour; tea or coffee flavours, such as a green tea flavour, a oolong tea flavour, a tea flavour, a cocoa flavour, a chocolate flavour, and a coffee flavour; mint flavours, such as a peppermint flavour, a spearmint flavour, and a Japanese mint flavour; spicy flavours, such as an asafetida flavour, an ajowan flavour, an anise flavour, an angelica flavour, a fennel flavour, an allspice flavour, a cinnamon flavour, a camomile flavour, a mustard flavour, a cardamom flavour, a caraway flavour, a cumin flavour, a clove flavour, a pepper flavour, a coriander flavour, a sassafras flavour, a savoury flavour, a Zanthoxyli Fructus flavour, a perilla flavour, a juniper berry flavour, a ginger flavour, a star anise flavour, a horseradish flavour, a thyme flavour, a tarragon flavour, a dill flavour, a capsicum flavour, a nutmeg flavour, a basil flavour, a marjoram flavour, a rosemary flavour, a bay leaf flavour, and a wasabi (Japanese horseradish) flavour; alcoholic flavours, such as a wine flavour, a whisky flavour, a brandy flavour, a rum flavour, a gin flavour, and a liqueur flavour; floral flavours; and vegetable flavours, such as an onion flavour, a garlic flavour, a cabbage flavour, a carrot flavour, a celery flavour, mushroom flavour, and a tomato flavour. These flavouring agents may be used in liquid or solid form and may be used individually or in admixture. Commonly used flavours include mints such as peppermint, menthol, spearmint, artificial vanilla, cinnamon derivatives, and various fruit flavours, whether employed individually or in admixture. Flavours may also provide breath freshening properties, particularly the mint flavours when used in combination with the cooling agents, described herein below.

An effervescent system may be incorporated into the confectionery composition. Such a system may include one or more edible acids and one or more edible alkaline materials. The edible acid(s) and the edible alkaline material(s) may react together to generate effervescence.

In some embodiments, the confectionery composition incorporates throat soothing ingredients, such as but not limited to analgesics, anaesthetics, demulcents, antiseptic, and combinations thereof. In some embodiments, analgesics/anaesthetics can include menthol, phenol, hexylresorcinol, benzocaine, dyclonine hydrochloride, benzyl alcohol, salicyl alcohol, and combinations thereof. In some embodiments, demulcents can include but are not limited to slippery elm bark, pectin, gelatin, and combinations thereof. In some embodiments, antiseptic ingredients can include cetylpyridinium chloride, domiphen bromide, dequalinium chloride, and combinations thereof.

In some embodiments, antitussive ingredients, such as but not limited to chlophedianol hydrochloride, codeine, codeine phosphate, codeine sulfate, dextromethorphan, dextromethorphan hydrobromide, dextrorphan, diphenhydramine, hydrocodone, noscapine, oxycodone, pentoxyverine, diphenhydramine citrate, and diphenhydramine hydrochloride, and combinations thereof can be included.

In some embodiments, throat soothing agents such as honey, propolis, aloe vera, glycerine, menthol and combinations thereof can be included. In still other embodiments, cough suppressants can be included. Such cough suppressants can fall into two groups: those that alter the consistency or production of phlegm such as mucolytics and expectorants; and those that suppress the coughing reflex such as codeine (narcotic cough suppressants), antihistamines, dextromethorphan and isoproterenol (non-narcotic cough suppressants). In some embodiments, ingredients from either or both groups can be included.

In some embodiments, antihistamines can include, but are not limited to, acrivastine, azatadine, brompheniramine, chlorpheniramine, clemastine, cyproheptadine, dexbrompheniramine, dimenhydrinate, diphenhydramine, doxylamine, hydroxyzine, meclizine, phenindamine, phenyltoloxamine, promethazine, pyrilamine, tripelennamine, triprolidine and combinations thereof. In some embodiments, non-sedating antihistamines can include, but are not limited to, astemizole, cetirizine, ebastine, fexofenadine, loratidine, terfenadine, and combinations thereof.

In some embodiments, expectorants can include, but are not limited to, ammonium chloride, guaifenesin, ipecac fluid extract, potassium iodide and combinations thereof. In some embodiments, mucolytics can include, but are not limited to, acetylcysteine, ambroxol, bromhexine and combinations thereof. In some embodiments, analgesic, antipyretic and anti-inflammatory agents can include, but are not limited to, acetaminophen, aspirin, diclofenac, diflunisal, etodolac, fenoprofen, flurbiprofen, ibuprofen, ketoprofen, ketorolac, nabumetone, naproxen, piroxicam, caffeine, and mixtures thereof. In some embodiments, local anaesthetics can include, but are not limited to, lidocaine, benzocaine, phenol, dyclonine, benzonotate and mixtures thereof.

In some embodiments nasal decongestants and ingredients that provide the perception of nasal clearing can be included. In some embodiments, nasal decongestants can include but are not limited to phenylpropanolamine, pseudoephedrine, ephedrine, phenylephrine, oxymetazoline, and combinations thereof. In some embodiments ingredients that provide a perception of nasal clearing can include but are not limited to menthol, camphor, borneol, ephedrine, eucalyptus oil, peppermint oil, methyl salicylate, bornyl acetate, lavender oil, wasabi extracts, horseradish extracts, and combinations thereof. In some embodiments, a perception of nasal clearing can be provided by odoriferous essential oils, extracts from woods, gums, flowers and other botanicals, resins, animal secretions, and synthetic aromatic materials.

The confectionery composition of the invention may be a chewing gum product, a chocolate bar, a chocolate coated product, a hard candy, a chewy candy, a crunchy candy or a soft candy product.

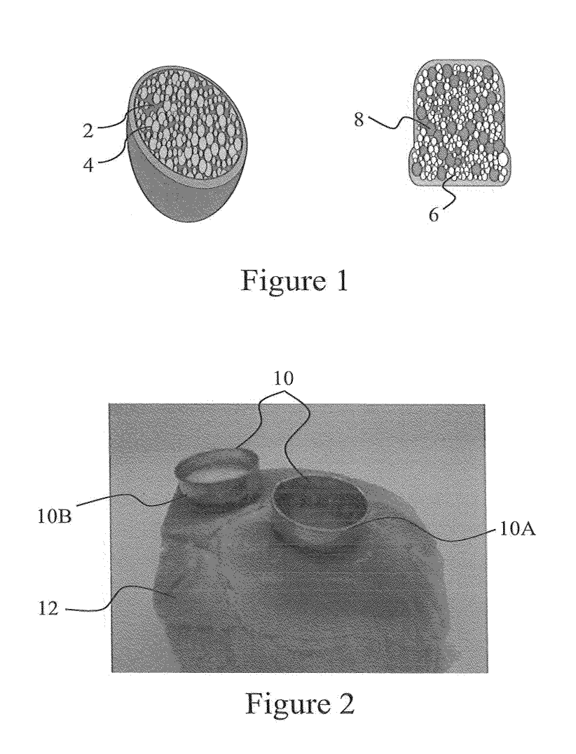

FIG. 1 shows two separate possible embodiments of the invention. The left hand embodiment shows a chocolate-based interconnected porous matrix structure 2 which has been filled with a fondant fill material 4, while the right hand embodiment shows a confectionery shell and porous matrix structure 6 having a strawberry flavour which has been filled with an apple flavour fill material 8.

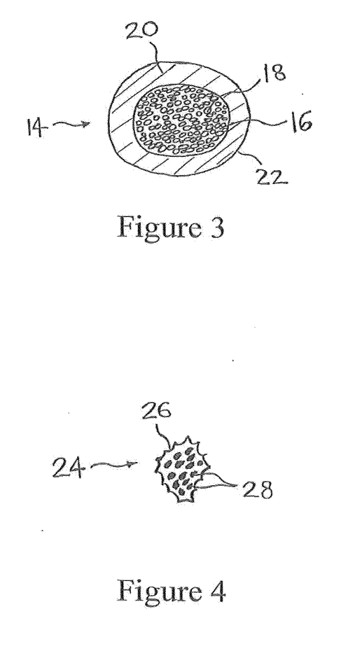

FIG. 2 shows an experiment to compare the relative infiltration rates of a fill material—in this case cocoa butter—with and without the presence of a surfactant into a brioche.

The cocoa butter was poured at a temperature of 31° C. into biscuit cutters 10 placed on top of the brioche 12. The cocoa butter infiltrated into the pores in the brioche 12, the sample 10A containing cocoa butter plus surfactant infiltrating quicker and deeper into the matrix in the brioche. It can be seen in FIG. 2 that the biscuit cutter 10B with the cocoa butter not containing surfactant is significantly fuller than the biscuit cutter 10A with the cocoa butter containing surfactant. This is due to the sample containing cocoa butter alone not being able to pass through the pores quickly enough and therefore eventually hardening on the surface of the brioche 12 as its temperature cooled down.

A further experiment to compare the relative infiltration rates of a fill material, with and without the presence of a surfactant, was carried out with a jelly. Again, cocoa butter was used as the fill material. A number of holes were created by hand through the jelly for the cocoa butter to pass through. The jelly proved to be a successful porous matrix. Using a yellow jelly with cocoa butter plus a caramel colour made the infiltration process clearly visible.

Again, the cocoa butter was poured at a temperature of 31° C. into biscuit cutters placed on top of the jelly, and time was recorded to establish how long it took for the first drop of butter to pass through the jelly and how long it took for all of the butter to completely pass through the system.

The sample with the surfactant passed through the holes first and at a faster rate:

With surfactant=15 seconds for it all to pass through

Without surfactant=20 seconds for it all to pass through

This constitutes a 25% increase in infiltration rate over a short period of time. Of course, the time to pass though the matrix is highly dependant on the size of the pores. To further emphasise the difference in time for fill materials with surfactant versus those without surfactant, and more accurately represent the size of the pores in e.g. a honeycomb porous matrix structure, it is envisaged that smaller pores could be made in the jelly and the experiments repeated.

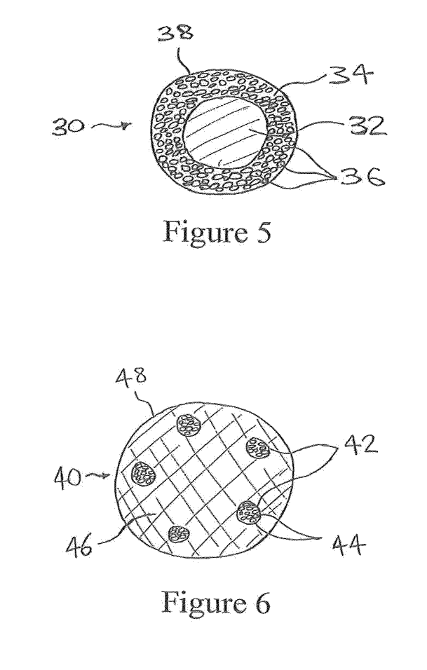

FIGS. 3-6 show four different embodiments of confectionery compositions according to the invention.

FIG. 3 illustrates a confectionery composition 14 having a porous candy centre 16 with interconnected pores. The porous candy centre 16 is filled using cocoa butter 18 as the fill material, and is surrounded with a chocolate coating layer 20. The chocolate coating layer 20 is further surrounded by a crispy outer shell layer 22.

FIG. 4 illustrates a porous candy composition 24 coated with a coating layer 26. The pores of the porous candy 24 are filled with chocolate 28.

FIG. 5 illustrates a porous candy composition 30 having a central portion comprising a gum 32, the gum 32 being surrounded by a porous candy layer 34 having interconnected pores, the pores being filled using chocolate 36 as the fill material. A crispy shell 38 provides the outer shell layer.

FIG. 6 illustrates a confectionery composition 40 having a number of porous honeycomb cavities 42 with interconnected pores at different locations in the composition 40. The fill material 44 is provided by a mint-flavoured liquid. Surrounding each of the porous honeycomb cavities 42 is chocolate 46, which may be either in liquid or solid form. The chocolate 46 is itself surrounded by an outer shell layer 48.

It is clearly shown that food systems can be used to demonstrate the impact of surfactant on filling a matrix of interconnected bubbles with a mobile phase in a confectionery composition. This surprising development allows confectionery shells having interconnected pores to be at least partially filled with a fill material to create a new series of confectionery compositions having different flavours and textures.

It is of course to be understood that the present invention is not intended to be restricted to the foregoing examples which are described by way of example only.

1. A confectionery composition comprising interconnected pores which are at least partially filled with a fill material, said fill material comprising a surfactant.

2. (canceled)

3. A confectionery composition according to claim 1, wherein the fill material comprises a liquid material, or a material which is liquid at a temperature greater than room temperature.

4. A confectionery composition according to claim 1, wherein the fill material comprises two or more components.

5. A confectionery composition according to claim 4, wherein the two or more components have different phases and/or form different phases at different temperatures.

6. A confectionery composition according to claim 1, wherein the fill material comprises is one or more liquid materials selected from fruit juice; vegetable juice; fruit puree; fruit pulp; vegetable pulp; vegetable puree; fruit sauce; vegetable sauce; honey; maple syrup; molasses; corn syrup; sugar syrup; polyol syrup; hydrogenated starch hydrolysates syrup; emulsions; vegetable oil; glycerin; propylene glycol; ethanol; liqueurs; chocolate syrup, dairy-based liquids such as milk or cream; mousse; gel; fondant; butter; cocoa butter; jam; a gelatin-comprising solution; an isomalt-comprising solution; icing sugar; and combinations thereof.

7. A confectionery composition according to claim 1, wherein the interconnected pores are located towards a central portion of the composition.

8. A confectionery composition according to claim 1, wherein the interconnected pores are located towards a peripheral position in the composition.

9. A confectionery composition according to claim 1, wherein the composition comprises two or more separate areas which contain interconnected pores.

10. A confectionery composition according to claim 1, wherein the confectionery further comprises a coating which at least partially surrounds the interconnected pores.

11. A confectionery composition according to claim 10, wherein the interconnected pores and/or coating comprises chocolate, gum, hard candy, chewy candy, crunchy candy or soft candy.

12. A confectionery composition according to claim 10, wherein the confectionery component further comprises an outer shell.

13. A confectionery composition according to claim 12, wherein the outer shell comprises a hard, crunchy or soft shell.

14. A confectionery composition according to claim 10, wherein the coating comprises more than one layer.

15. A confectionery composition according to claim 1, wherein the product is a chewing gum, a chocolate bar, a chocolate-coated product, a hard candy, a chewy candy, a crunchy candy or a soft candy product.

16. A method of producing a confectionery composition, comprising the steps of:
i) providing an edible porous structure having interconnected pores; and
ii) at least partially filling the pores with an edible fill material, said edible fill material comprising a surfactant.

17. (canceled)

18. A method according to claim 16, wherein the method further comprises the step of mixing the fill material with the surfactant, prior to said step of at least partially filling the pores with the fill material.

19. A method according to claim 16, wherein the fill material is heated to above room temperature prior to being used to at least partially fill the pores.

20. A method according to claim 1, wherein the step of at least partially filling the pores with a fill material comprises at least partially submerging the porous structure in a quantity of liquefied fill material.

21. (canceled)

22. Use of a surfactant in modifying flow properties of a fill material in the preparation of a confectionery composition.

23. (canceled)
